(19) United States
(12) Patent Application Publication
(10) Pub. No.: US 2014/0035474 A1
(43) Pub. Date: Feb. 6, 2014

(54) HIGH EFFICIENCY LED DRIVER CHIP AND DRIVER CIRCUIT THEREOF

(71) Applicant: Anwell Semiconductor Corp., Hsin-Chu City (TW)

(72) Inventors: CHUN-CHIEH KUO, HSIN-CHU CITY (TW); KE-HORNG CHEN, HSIN-CHU CITY (TW); SHAO-WEI CHIU, HSIN-CHU CITY (TW)

(73) Assignee: Anwell Semiconductor Corp., Hsin-Chu City (TW)

(21) Appl. No.: 13/951,723

(22) Filed: Jul. 26, 2013

(30) Foreign Application Priority Data
Aug. 3, 2012 (TW) 101127973

(51) Int. Cl. H05B 33/08

(52) U.S. Cl. CPC H05B 33/0848
USPC 315/200 R; 315/247

(57) ABSTRACT

Disclosed is a high-efficiency LED driver chip and a driver circuit of the chip, and the driver chip includes a detection unit, a comparison unit and a correction unit. The LED detection unit detects the operating current of the LED driver circuit by an external sensing resistor and an internal current mirror to output a setup signal, and the comparison unit detects the driving current of at least one LED by an external comparing resistor to output an initialization signal, so that the correction unit can output a correction signal according to the setup signal and the initialization signal to reduce the power loss of the circuit while maintaining the driving current constant, so as to improve the illumination quality and the service life of the LED.

### CROSS-REFERENCE TO RELATED APPLICATIONS

This non-provisional application claims priority under 35 U.S.C. § 119(a) on Patent Application No(s). 101127973 filed in Taiwan, R.O.C. on Aug. 3, 2012, the entire contents of which are hereby incorporated by reference.

### BACKGROUND OF THE INVENTION

1. Field of the Invention

The present invention relates to the technical field of circuit devices for electric light sources, and more particularly to a low-cost high-efficiency LED driver chip and a driver circuit thereof capable of reducing the power loss of the overall circuit to achieve high electric power conversion efficiency effectively.

2. Description of the Related Art

At present, light emitting diode (LED) with its low power consumption, long life, small volume, quick response and low price hits the entire illumination market and becomes increasingly more popular in the application for illumination lamps such as desk lamps, patio lamps, signal lights, advertising billboards, etc. According to the LED current/voltage (I/V) characteristic curve, LED is not a linear device, and thus the driving current will be increased with the time of use, and the LED may blink easily due to the insufficient current supply of the power supply device. Limited by the output of low voltage and high current from a power supply device, each parallel LED light string has a different driving current to produce a different brightness. As a result, the service life of each LED lamp is different, and the quality of the lamps will be affected adversely. To overcome this problem, the driver circuit of the conventional LED lamp as shown in FIG. 1 is a constant current driver circuit 1, such that at least one LED set 2 is connected to a transistor 10 and a sensing resistor 11 in series, and the sensing resistor 11 detects a voltage drop of the driving current I formed at both ends of an LED set 2 and feeds back the voltage drop to a comparator 12. The comparator 12 compares the voltage drop fed back by the sensing resistor 11 with a standard voltage, and if the standard voltage is greater than the voltage drop, the comparator 12 will output a high-level signal, or else the comparator 12 will output a low-level signal to conduct or cut off the transistor 10 and the duty ratio of the pulse width modulation (PWM) signal is provided for adjusting the driving voltage to maintain the driving current I of the LED set 2 constant.

Although the aforementioned constant-current driver circuit 1 is applicable for the utility power of 80-260V for a convenient use, yet components of the circuit 1 have a power loss up to a certain level and affect the electric power conversion of the entire circuit significantly, and if voltage frequency of the PWM signal is too low, the blinking problem of the LEDs may occur easily, and if the voltage frequency of the PWM signal is too high, noise interference may occur due to a too-fast change of high- and low-level voltages, so that the LED may work abnormally and reduce the practicality of the LED.

### SUMMARY OF THE INVENTION

In view of the aforementioned problems of the prior art, it is a primary objective of the present invention to overcome the problems by providing a low-cost high-efficiency LED driver chip and a driver circuit thereof, wherein a capacitive electric power converter is provided for eliminating any ripple current to reduce the total harmonic distortion (THD), and a power factor correction method is used to control a constant LED current, so as to improve the electric power conversion efficiency.

To achieve the aforementioned objective, the present invention provides a high-efficiency LED driver chip applicable in an LED driver circuit, for detecting an operating current of the LED driver circuit and a driving current of at least one LED to correct a power factor and improve a circuit efficiency, comprising: a detection unit, coupled to the LED driver circuit by an external sensing resistor, for detecting the operating current, and including: a current mirror, having a first transistor installed at an end of the current mirror; a first comparator, coupled to the first transistor and the sensing resistor, for comparing a voltage drop of the operating current formed at both ends of the sensing resistor by a reference value to conduct or cut off the first transistor; and a second comparator, coupled to the other end of the current mirror opposite to the first transistor, for comparing a voltage drop of the operating current formed at both ends of the sensing resistor with a set value when the first transistor is conducted, and outputting a setup signal if the voltage drop is smaller than the set value; a comparison unit, coupled to the LED through an external comparing resistor, for detecting the driving current, comparing the driving current with a reference value to amplify and form a voltage difference value, and outputting an initialization signal if the voltage difference value is greater than an upper limit value; and a correction unit, electrically coupled to the detection unit and the comparison unit, for receiving the setup signal and the initialization signal to output a correction signal.

Wherein, the first transistor is a N-type metal oxide semiconductor field effect transistor (MOSFET), and the current mirror includes a second transistor, a third transistor and a current resistor. The second transistor and the third transistor are P-type metal oxide semiconductor field effect transistors having gates coupled to each other, and the third transistor has a drain coupled the current resistor and a negative input terminal of the second comparator, and the second transistor has a gate coupled to a drain of the second transistor and a drain of the first transistor, and the first transistor has a gate coupled to an output terminal of the first comparator. The comparison unit includes a sawtooth wave generator for outputting a sawtooth wave to produce the upper limit value, and the comparison unit compares the compensated voltage difference value with the upper limit value. The correction unit includes a flip flop coupled to the output terminal of the second comparator and the output terminal of the comparison unit for receiving the setup signal and the initialization signal. In addition, the high-efficiency LED driver chip further comprises a modulation unit and a protection unit, and the modulation unit is electrically coupled to the correction unit, and a sensing transistor and a sensing resistor of the LED driver circuit for sensing a voltage drop of the driving current formed at both ends of the sensing resistor to analyze and obtain a modulation signal in order to cut off the sensing transistor, and the protection unit is electrically coupled to the correction unit and the modulation unit for limiting the voltage of the correction signal and the modulation signal.

To achieve the objective of the present invention, the invention further provides a high-efficiency LED driver circuit applicable for the aforementioned high-efficiency LED driver chip to drive and maintain the illumination brightness of the LED constant. The high-efficiency LED driver circuit comprises a rectification module, a conversion module and a control module. The rectification module is electrically coupled to a power supply for receiving an AC voltage to output a variable DC voltage. The conversion module is electrically coupled to the rectification module and the LED and had a conversion switch for receiving and converting the DC voltage when the conversion switch is cut off in order to boost the operating voltage to drive the LED. The control module is coupled to the conversion module through the sensing resistor and coupled to the LED through the comparing resistor, for detecting a voltage drop of the operating current formed at both ends of the sensing resistor and comparing the voltage drop with another voltage drop of the driving current formed at both ends of the comparing resistor to output the correction signal to conduct the conversion switch, so that the conversion module enters into a transient state and delays the output of the operating voltage.

Wherein, the control module includes a sensing transistor and a sensing resistor, and the sensing transistor is an N-type metal oxide semiconductor field effect transistor having a drain coupled to the LED and the comparing resistor and a source coupled to the sensing resistor, and the control module senses the voltage drop of the driving current formed at both ends of the sensing resistor to cut off the sensing transistor to adjust the current intensity of the driving current. The rectification module is a full-wave bridge rectifier having a bidirectional triode thyristor (TRIAL) coupled between the power supply and the full-wave bridge rectifier for receiving and adjusting a phase conduction angle of the AC voltage to adjust the conduction period of the DC voltage, and the conversion module is a single-ended primary inductance converter or a boost inductance converter.

In summation, the present invention detects the operating current by the sensing resistor when the inductor of the conversion module discharges electricity, and the comparison unit monitors the driving current and adjusts the conversion module when the driving current exceeds a normal tolerance in order to correct the power factor and improve the electric power conversion efficiency to a level over 95%. In addition, the constant current maintains a consistent illumination brightness of the LED to improve the illumination effect and the service life of the LED.

### BRIEF DESCRIPTION OF THE DRAWINGS

FIG. 1 is a circuit diagram of a conventional constant-current driver circuit;

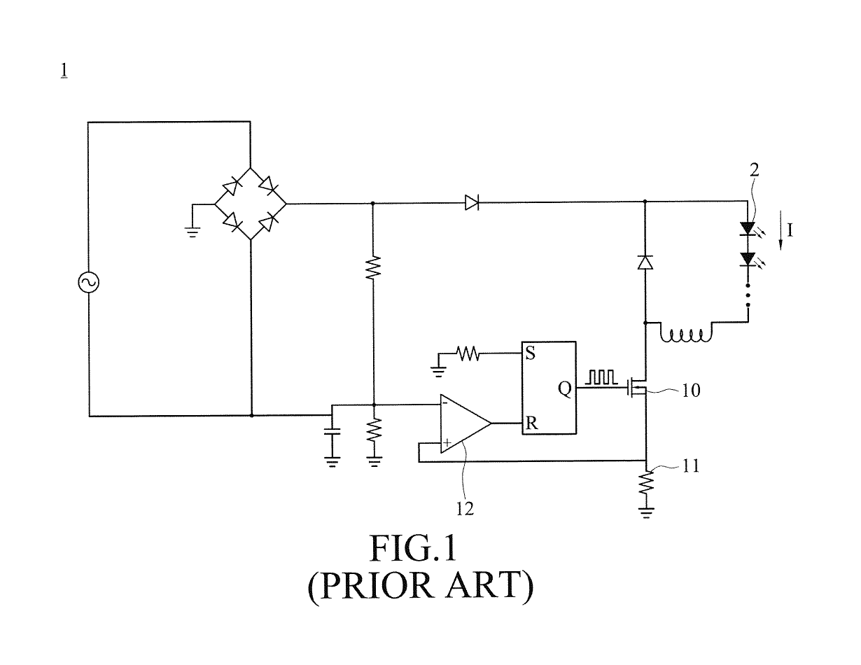

FIG. 2 is a block diagram of a preferred embodiment of the present invention;

FIG. 3 is a circuit diagram of a driver chip of a preferred embodiment of the present invention;

FIG. 4 is a circuit diagram of a driver circuit of a preferred embodiment of the present invention;

FIG. 5 is a circuit diagram of another driver circuit of a preferred embodiment of the present invention;

FIG. 6 is a circuit diagram of a further driver circuit of a preferred embodiment of the present invention; and

FIG. 7 is a waveform diagram of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

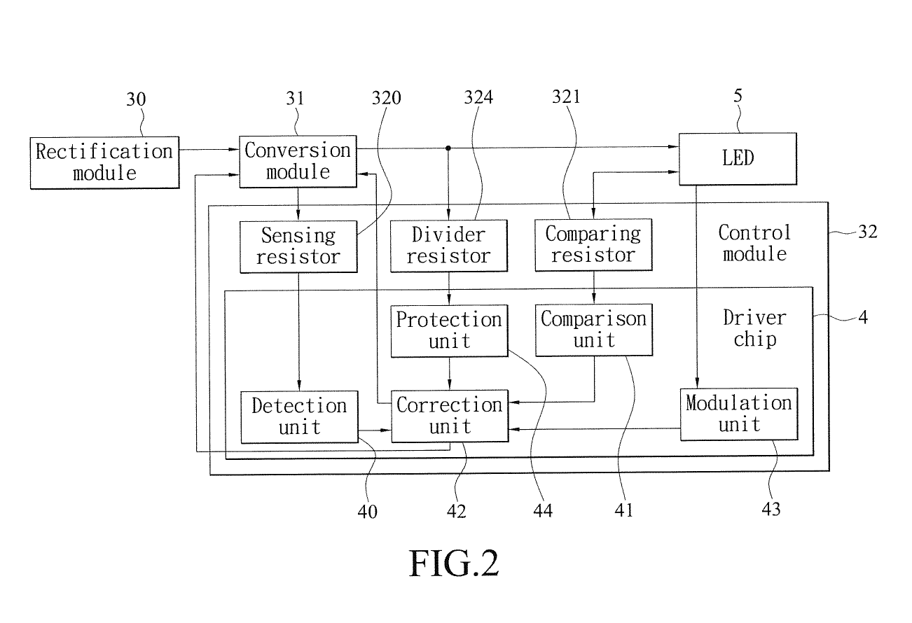

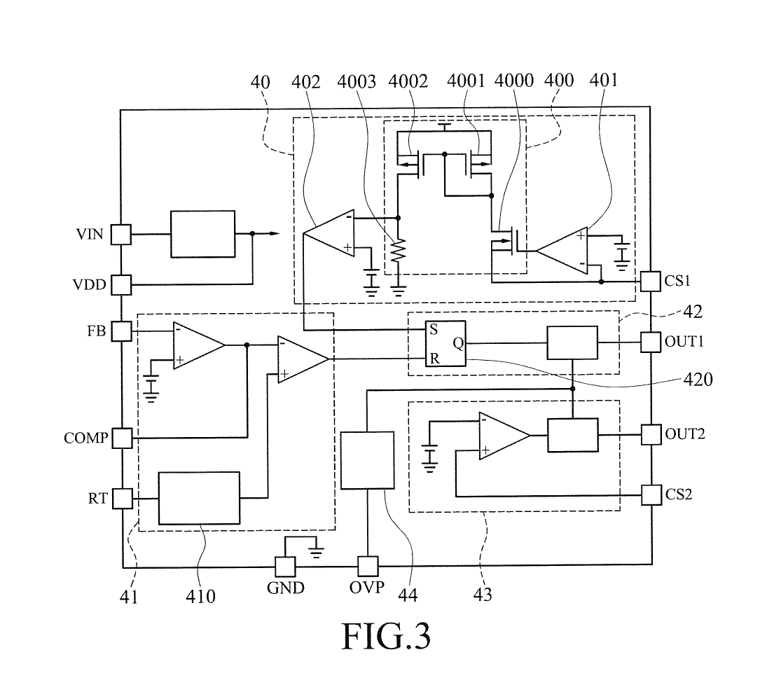

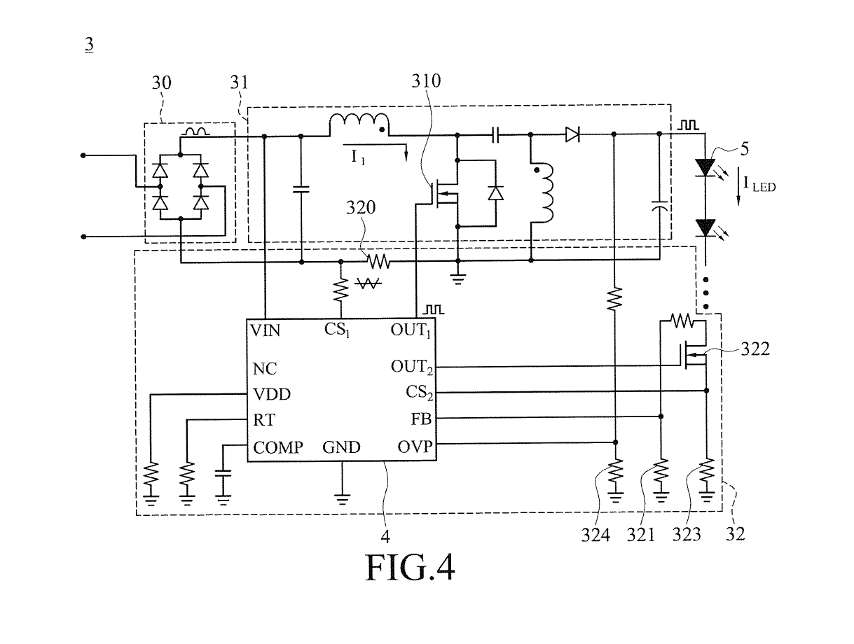

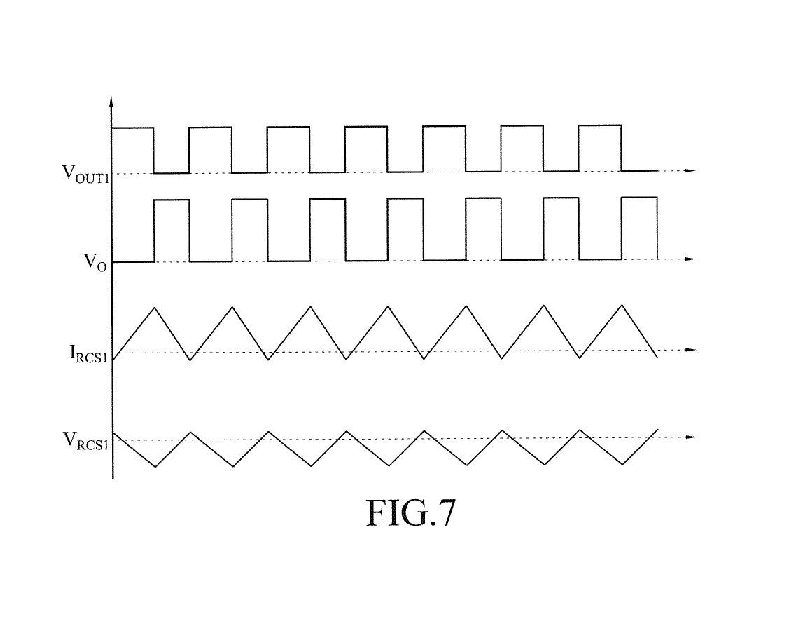

With reference to FIGS. 2 to 4 and 7 for a block diagram, a circuit diagram of a driver chip, a circuit diagram of the driver circuit and a waveform diagram of a preferred embodiment of the present invention respectively. As shown in the figures, a high-efficiency LED driver circuit 3 uses the high-efficiency LED driver chip 4 to detect its operating current I_{L} and a driving current I_{LED} of at least one LED 5 to correct the power factor and output a constant current, so as to achieve the effects of stabilizing the illumination brightness of the LED 5 and improving the circuit efficiency. The driver circuit 3 comprises a rectification module 30, a conversion module 31 and a control module 32. The control module 32 includes a sensing resistor 320, a comparing resistor 321, a sensing transistor 322, a sensing resistor 323, a divider resistor 324 and the driver chip 4. The driver chip 4 includes a detection unit 40, a comparison unit 41, a correction unit 42, a modulation unit 43 and a protection unit 44. The sensing transistor 322 is an N-MOSFET having a drain coupled to the LED 5 and the comparing resistor 321, a source coupled to the sensing resistor 323 and an input terminal (CS₂) of the modulation unit 43, and a gate coupled to an output terminal (OUT₂) of the modulation unit 43. The rectification module 30 is electrically coupled to an AC power of 85-265V (not shown in the figure) and the conversion module 31. The rectification module 30 is a full-wave bridge rectifier for receiving an AC voltage to output a variable DC voltage. The conversion module 31 is electrically coupled to the LED 5, and the conversion module 31 is an inductance converter having a conversion switch 310, such that when the conversion switch 310 is cut off, the DC voltage is converted into a boosted operating voltage (Vₒ) to drive the LED 5. The control module 32 couples the conversion module 31 to an input terminal (CS₁) of the detection unit 40 through the sensing resistor 320 for detecting the operating current I_{L}. The LED 5 is also coupled to an input terminal (FB) of the comparison unit 41 through the comparing resistor 321 for detecting the driving current I_{LED}; and the conversion module 31 is coupled to an input terminal (OVP) of the protection unit 43 through the divider resistor 324 for detecting the boosted operating voltage.

The detection unit 40 includes a current mirror 400, a first comparator 401 and a second comparator 402, and the current mirror 400 is comprised of a first transistor 4000, a second transistor 4001, a third transistor 4002 and a current resistor 4003. The first transistor 4000 is an N-type MOSFET. The second transistor 4001 and the third transistor 4002, having their gates coupled to each other, are P-type MOSFETs, and the gate of the second transistor 4001 is coupled to a drain of the second transistor 4001 and a drain of the first transistor 4000. The first comparator 401 has a negative input terminal coupled to a source of the first transistor 4000, a positive input terminal coupled to a voltage source to form a reference value, and an output terminal coupled to a gate of the first transistor 4000. The second comparator 402 has a negative input terminal coupled to a drain of the third transistor 4002 and the current resistor 4003, a positive input terminal coupled to a voltage source to form a set value, and an output terminal coupled to an input terminal of a RS flip flop 420 of the corrector 42. Therefore, when the control module 32 detects a voltage drop (V_{RSC1}) formed at both ends after the operating current I_{L} has passed through the sensing resistor 320 (I_{RSC1}), the first comparator 401 compares the voltage drop (V_{RSC1}) with the reference value to conduct the first transistor 4000. With the characteristic of having corresponding current at both ends of the current mirror 400, the second comparator 402 further compares the voltage drop (V_{RSC1}) with the set value, and if the voltage drop (V_{RSC1}) is smaller than the set value, a setup signal will be outputted, so that the correction unit 42 will output a low-voltage correction signal (V_{OUT1}) from the output terminal (OUT₁) to cut off the conversion switch 310.

In the meantime, the control module 32 detects a voltage drop of the driving current I_{LED} formed at both ends of the comparing resistor 321, and the comparison unit 41 compares the voltage drop of the driving current I_{LED} with a reference value to amplify and form a voltage difference value for compensation. Further, the comparison unit 41 includes a sawtooth wave generator 410 for outputting a sawtooth wave to define an upper limit value, and the comparison unit 41 outputs an initialization signal to the other input terminal of the RS flip flop 420 when the compensated voltage difference value is greater than the upper limit value, and thus the correction unit 42 will output a high-voltage correction signal to conduct the conversion switch 310, and the conversion module 31 will enter into a transient state and delay the output of the operating voltage.

In addition, the correction unit 42 is coupled to the modulation unit 43 and the protection unit 44. If the modulation unit 43 senses and determines that the voltage drop of the driving current I_{LED} formed at both ends of the sensing resistor 323 is greater than a predetermined numerical value, the modulation unit 43 outputs a modulation signal and cut off the sensing transistor 322 to reduce the current intensity of the driving current I_{LED}. Such arrangement can maintain the driving current I_{LED} constant and minimize the power loss, so as to lower the circuit temperature and improve the service life. To avoid damaging the LED 5 by an output of a too-large voltage of the conversion module 31, the protection unit 44 limits the voltage intensity of the correction signal and the modulation signal when the voltage drop formed at both ends of the divider resistor 324 is greater than a predetermined numerical value, so as to compulsorily outputting a low voltage to cut off the conversion switch 310 and the sensing transistor 322 in order to adjust the power factor accurately and improve the efficiency effectively.

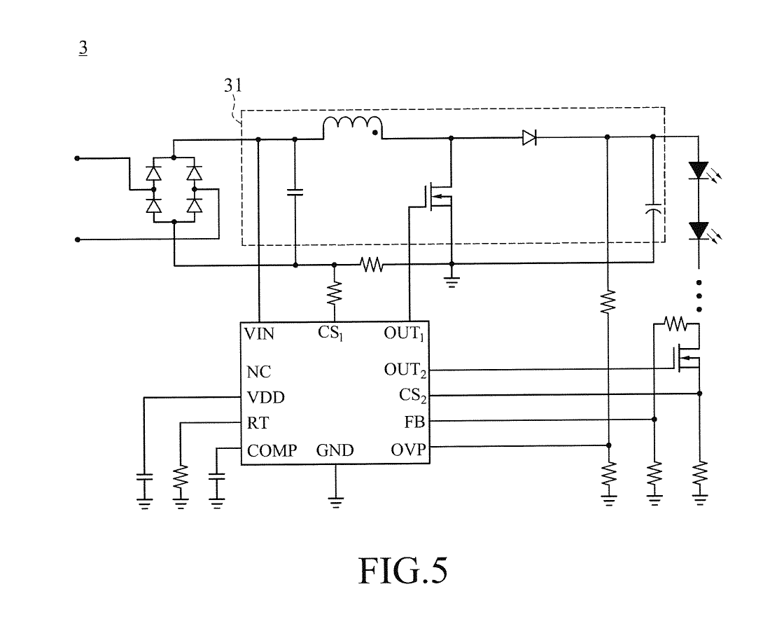

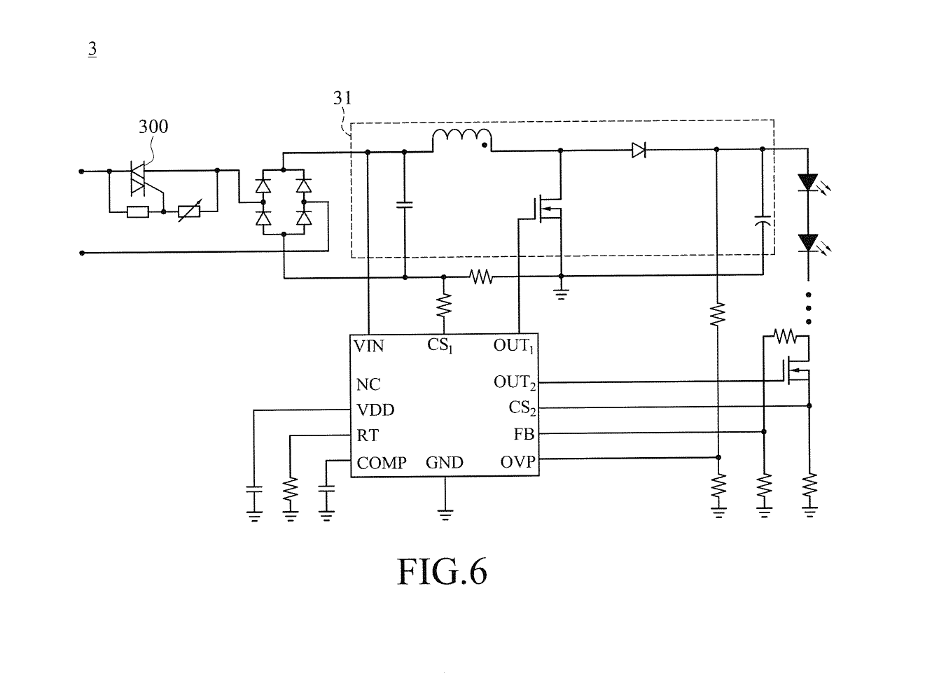

In this preferred embodiment, the conversion module can be set according to a SEPIC topology or a BOOST conversion module as shown FIG. 5 (depicting another circuit diagram of the driver circuit in accordance with a preferred embodiment of the present invention). To ensure achieving a high electric power conversion efficiency, the driver circuit as shown in FIG. 6 (depicting a further circuit diagram of the driver circuit in accordance with a preferred embodiment of the present invention), the rectification module includes a TRIAC 300 coupled between an AC power and the full-wave bridge rectifier. So that after the TRIAC 300 has received the AC voltage, the phase angle of conduction is adjusted to change the conduction period of the DC voltage; as such, the output frequency of the operating voltage can be controlled linearly to avoid having the problems of blinking or noise interference and affecting the normal operation of the LED 5.

What is claimed is:

1. A high-efficiency LED driver chip, applicable in an LED driver circuit, for detecting an operating current of the LED driver circuit and a driving current of at least one LED to correct a power factor and improve a circuit efficiency, comprising:
a detection unit, coupled to the LED driver circuit by an external sensing resistor, for detecting the operating current, and including:
a current mirror, having a first transistor installed at an end of the current mirror;
a first comparator, coupled to the first transistor and the sensing resistor, the first comparator comparing a voltage drop of the operating current formed at both ends of the sensing resistor by a reference value to conduct or cut off the first transistor; and
a second comparator, coupled to the other end of the current mirror opposite to the first transistor, the second comparator comparing a voltage drop of the operating current formed at both ends of the sensing resistor with a set value when the first transistor is conducted, and outputting a setup signal if the voltage drop is smaller than the set value;
a comparison unit, coupled to the LED through an external comparing resistor and detecting the driving current, the comparison unit comparing the driving current with a reference value to amplify and form a voltage difference value, the comparison unit outputting an initialization signal if the voltage difference value is greater than an upper limit value; and
a correction unit, electrically coupled to the detection unit and the comparison unit, for receiving the setup signal and the initialization signal to output a correction signal.

2. The high-efficiency LED driver chip of claim 1, wherein the first transistor is a N-type metal oxide semiconductor field effect transistor, and the current mirror includes a second transistor, a third transistor and a current resistor, and the second transistor and the third transistor are P-type metal oxide semiconductor field effect transistors having gates coupled to each other, and the third transistor has a drain coupled the current resistor and a negative input terminal of the second comparator, and the second transistor has a gate coupled to a drain of the second transistor and a drain of the first transistor, and the first transistor has a gate coupled to an output terminal of the first comparator.

3. The high-efficiency LED driver chip of claim 2, wherein the comparison unit includes a sawtooth wave generator for outputting a sawtooth wave to produce the upper limit value, and the comparison unit compares the compensated voltage difference value with the upper limit value.

4. The high-efficiency LED driver chip of claim 3, wherein the correction unit includes a flip flop coupled to the output terminal of the second comparator and the output terminal of the comparison unit for receiving the setup signal and the initialization signal.

5. The high-efficiency LED driver chip of claim 4, further comprising a modulation unit and a protection unit, the modulation unit being electrically coupled to the correction unit, a sensing transistor, and a sensing resistor of the LED driver circuit, for sensing a voltage drop of the driving current formed at both ends of the sensing resistor to analyze and obtain a modulation signal in order to cut off the sensing transistor, and the protection unit being electrically coupled to the correction unit and the modulation unit for limiting the voltage of the correction signal and the modulation signal.

6. A high-efficiency LED driver circuit, using the high-efficiency LED driver chip according to claim 1 to drive and maintain the illumination brightness of an LED constant, comprising:
a rectification module, electrically coupled to a power supply, for receiving an AC voltage to output a variable DC voltage;
a conversion module, electrically coupled to the rectification module and the LED, and having a conversion switch, for receiving and converting the DC voltage when the conversion switch is cut off in order to boost the operating voltage to drive the LED;
a control module, coupled to the conversion module through the sensing resistor and coupled to the LED through the comparing resistor, the control module detecting a voltage drop of the operating current formed at both ends of the sensing resistor, and comparing the voltage drop with another voltage drop of the driving current formed at both ends of the comparing resistor to output the correction signal to conduct the conversion switch, so that the conversion module enters a transient state and delays the output of the operating voltage.

7. The high-efficiency LED driver circuit of claim 6, wherein the control module includes a sensing transistor and a sensing resistor, and the sensing transistor is an N-type metal oxide semiconductor field effect transistor having a drain coupled to the LED and the comparing resistor and a source coupled to the sensing resistor, and the control module senses the voltage drop of the driving current formed at both ends of the sensing resistor to cut off the sensing transistor to adjust the current intensity of the driving current.

8. The high-efficiency LED driver circuit of claim 7, wherein the conversion module is a single-ended primary inductance converter or a boost inductance converter.

9. The high-efficiency LED driver circuit of claim 8, wherein the rectification module is a full-wave bridge rectifier.

10. The high-efficiency LED driver circuit of claim 9, wherein the rectification module includes a bidirectional triode thyristor (TRIAC) coupled to the power supply and the full-wave bridge rectifier, the bidirectional triode thyristor receives and adjusts a phase conduction angle of the AC voltage to modulate a conduction period of the DC voltage.
